(19) United States
(12) Patent Application Publication
(10) Pub. No.: US 2021/0365595 A1
(43) Pub. Date: Nov. 25, 2021

(54) LOCKING DEVICES WITH AUTHENTICATION

(71) Applicant: Hewlett-Packard Development Company, L.P., Spring, TX (US)

(72) Inventors: Chi Wai So, Spring, TX (US); Christopher Joseph, Spring, TX (US)

(73) Assignee: Hewlett-Packard Development Company, L.P., Spring, TX (US)

(21) Appl. No.: 17/059,591

(22) PCT Filed: Feb. 14, 2019
(86) PCT No.: PCT/US2019/017930

§ 371 Date: Nov. 30, 2020

(51) Int. Cl. G06F 21/85; G06F 21/30; G06F 21/32

(52) U.S. Cl. CPC G06F 21/85; G06F 21/32; G06F 21/305

(57) ABSTRACT

An example locking device includes a body to interface with a receptacle of a host computing device. An electromechanical locking mechanism is disposed in the body. The electromechanical locking mechanism engages the receptacle to secure the body in the receptacle. A processor is disposed in the body. The processor is electrically connected to the electromechanical locking mechanism to actuate the electromechanical locking mechanism. The processor receives a request to actuate the electromechanical locking mechanism and, in response to the request, perform an authentication on the request. The processor actuates the electromechanical locking mechanism in response to a successful authentication.

### BACKGROUND

Computing devices include receptacles, such as universal serial bus (USB) ports, for providing wired connections to external devices.

### BRIEF DESCRIPTION OF THE DRAWINGS

FIG. 1 is a perspective view of an example locking device with an authenticated electromechanical locking mechanism.

FIG. 2 is a schematic of an example locking device in use in a receptacle of a host computing device.

FIG. 3 is a schematic of another example locking device in use in a receptacle of a host computing device.

FIG. 4 is a schematic of another example locking device in use in a receptacle of a host computing device.

### DETAILED DESCRIPTION

Computing devices may have receptacles such as USB receptacles, which may pose security risks to computing devices, as they provide access to the computing device and may allow incoming and outgoing data transmissions. Computing device receptacles may also be at risk of physical damage by allowing foreign objects to be inserted into the receptacle. Computing devices may include personal computers, laptops, desktops, or other types of computing devices such as imaging devices, additive manufacturing devices, and the like.

To prevent unwanted foreign objects or unauthorized data transmission via computing device receptacles, users may physically close the receptacle, such as by applying an adhesive or the like to permanently seal the receptacle. Such solutions may damage the receptacle and render the receptacle unusable for future authorized use. Users may also insert manual plugs to temporarily block the receptacle. Such plugs are easily removed without authorization, exposing the computing device to physical damage or security breaches via the receptacle.

A locking device includes a body to interface with a receptacle or port of a host computing device. The locking device further includes an electromechanical locking mechanism disposed in the body. The electromechanical locking mechanism engages the receptacle to secure the body in the receptacle. The locking device further includes a processor disposed in the body, the processor electrically connected to the electromechanical locking mechanism to actuate the electromechanical locking mechanism. Specifically, the processor may receive a request to actuate the electromechanical locking mechanism, and, in response to the request, perform an authentication on the request. The processor may then actuate the electromechanical locking mechanism in response to a successful authentication.

The locking device thus performs an authentication procedure to allow only authorized users to remove the locking device from the receptacle. The locking device may thus be operated independently from the host computing device or other computing device. For example, the host computing device may be off, non-functional, or locked, The locking device performs authentication and thus does not rely on communications to other computing devices. Further, the self-contained authentication reduces the likelihood of receiving a falsely authenticated signal to actuate the locking mechanism. Further, the locking device may include a fingerprint sensor or other self-contained authentication functionality.

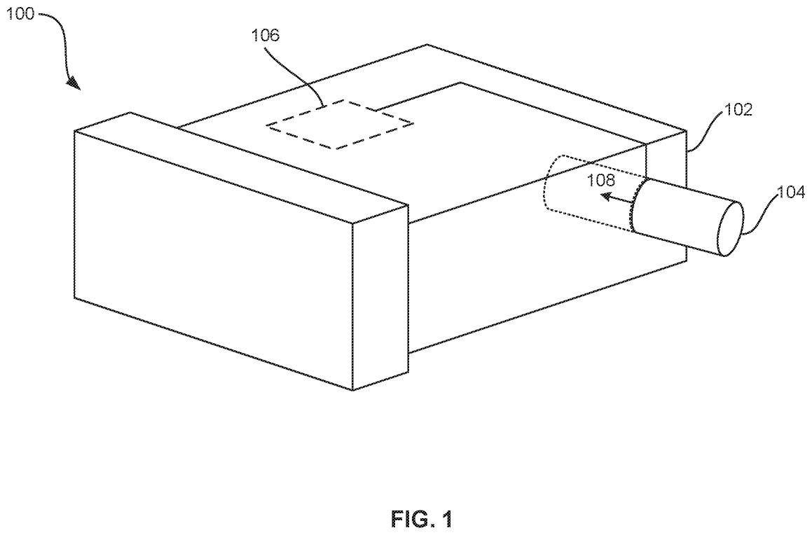

FIG. 1 shows an example locking device 100. The locking device 100 includes a body 102, an electromechanical locking mechanism 104, and a processor 106. The body 102 is to interface with a receptacle of a host computing device. The body 102 may be, for example, a universal serial bus (USB) plug, and accordingly, may be shaped to interface with a USB receptacle of the host computing device. The electromechanical locking mechanism 104 (also referred to as locking mechanism 104) is disposed in the body 102 and is to engage the receptacle of the host computing device to secure the body 102 and thereby the locking device 100 in the receptacle. The locking mechanism 104 is depicted in FIG. 1 in a position to engage the receptacle of the host computing device. The locking mechanism 104 may move in a direction 108 to disengage from the receptacle and to be housed in the body 102.

The processor 106 is disposed in the body 102. The processor 106 may include a central processing unit (CPU), a microcontroller, a microprocessor, a processing core, a field-programmable gate array (FPGA), or similar device capable of executing instructions. The processor 106 may cooperate with memory to execute instructions. Memory may include a non-transitory computer-readable storage medium that may be an electronic, magnetic, optical or other physical storage device that stores executable instructions. The computer-readable storage medium may include, for example, random access memory (RAM), read-only memory (ROM), electrically-erasable programmable read-only memory (EEPROM), flash memory, and the like. The computer-readable storage medium may be encoded with executable computer-readable instructions.

The processor 106 is electrically connected to the locking mechanism 104 to actuate the locking mechanism 104 via an electrical signal. Specifically, the processor 106 receives a request to actuate the locking mechanism 104. The request may be to unlock the locking mechanism 104 (i.e., to disengage the receptacle of the host computing device), or to lock the locking mechanism 104 (i.e., to engage the receptacle of the host computing device). In response to the request, the processor 106 performs an authentication on the request. In response to a successful authentication, the processor 106 actuates the locking mechanism 104 per the request.

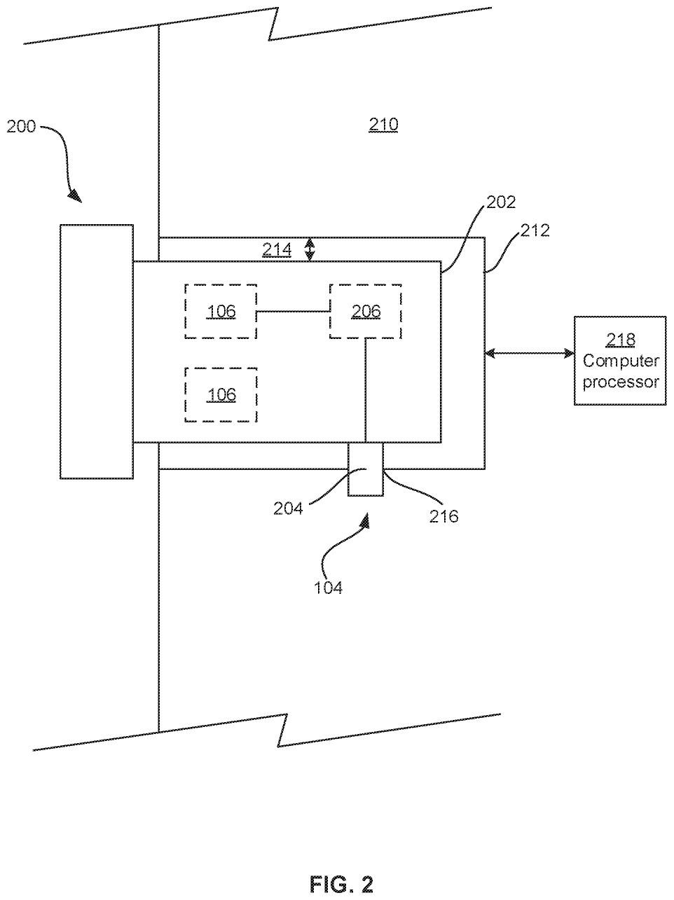

FIG. 2 depicts an example locking device 200 in a receptacle 212 of a host computing device210. The locking device 200 includes a body 202 to interface with the receptacle 212 to form a receptacle interface 214. Specifically, the body 202 and the receptacle 212 can include respective conductors that make electrical contact to form the receptacle interface 214. The locking device 200 further includes an electromechanical locking mechanism 104 disposed in the body to engage the receptacle 212 of the host computing device210 to secure the body 102 in the receptacle 212. The locking device 200 further includes a processor 106 disposed in the body and electrically connected to the locking mechanism 104 to actuate the locking mechanism 104. For example, the locking device 200 may include a solenoid 206 to interface with the processor 106 and the locking mechanism 104 to translate an actuation signal from the processor 106 into mechanical actuation of the locking mechanism 104. The locking device 200 further includes a memory 208 interconnected with the processor 106. The memory 208 can store instructions executable by the processor 106 to perform the functionality described herein.

The receptacle 212 and the locking mechanism 104 are shaped to allow the locking mechanism 104 to engage the receptacle 212 to secure the body 102 in the receptacle 212. For example, the locking mechanism 104 may include a bolt 204, and the receptacle 212 may include a corresponding aperture 216 to receive the bolt 204 of the locking device 200. For example, the locking mechanism 104 may be disposed in the body to engage a pre-existing aperture based on standard receptacle structure.

In some examples, the receptacle interface 214 may allow communications between the locking device 200 and the host computing device210. That is, the locking device 200 and the host computing device210 may communicate directly via the receptacle interface 214. The receptacle 212 may therefore be connected to a processor 218 of the host computing device210. For example, the host computing device may initiate a request to actuate the locking mechanism 104. For example, the request may be to unlock the locking mechanism 104 to allow the locking device 100 to be removed from the receptacle 212. The request may be received at the processor 106 from the host computing device210 via the receptacle interface 214.

In response to the request, the processor 106 performs an authentication on the request. In some examples, the processor 106 may receive authentication data to perform the authentication on the request. The authentication data may be received for example, concurrently with the request, as a part of the request, or the processor 106 may request the authentication data. For example, the processor 106 may communicate via the receptacle interface to the host computing device210 to request authentication data from the host computing device210.

The authentication data may be, for example, a password, a pin, biometric data, combinations of such or the like received at the host computing device210. The processor 106 may perform the authentication, for example, by verifying the received authentication data against authorized data stored at the locking device 200. In other examples, as described further below, the processor 106 may receive the authentication data from a different device. In response to a successful authentication, the processor 106 actuates the electromechanical locking mechanism 104, for example via the solenoid 216. In response to an unsuccessful authentication, the processor 106 does not actuate the locking mechanism 104. In some examples, the processor 106 may communicate a notification indicating that the authentication was unsuccessful to the requesting device (e.g., the host computing device210).

In some examples, the receptacle interface 214 may further allow the locking device 200 to draw power from the host computing device210. Specifically, the locking device 200 may draw power to support the processor 106 and the electromechanical locking mechanism 104.

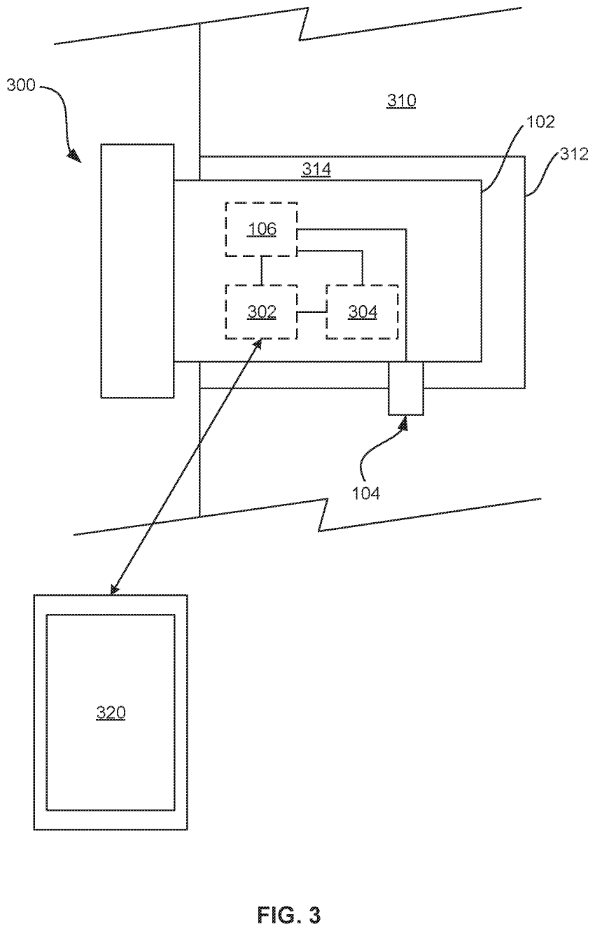

FIG. 3 depicts an example locking device 300 in a receptacle 312 of a host computing device310. The locking device 300 includes a body 102 to interface with the receptacle 312 to form a receptacle interface 314. The locking device 300 further includes an electromechanical locking mechanism 104 disposed in the body 102 to engage the receptacle 312 to secure the body 102 in the receptacle 312. The locking device 300 further includes a processor 106 disposed in the body 102 and electrically connected to the locking mechanism 104 to actuate the locking mechanism 104.

The locking device 300 further includes a wireless communications interface 302 interconnected with the processor 106. The wireless communications interface 302 includes suitable hardware (e.g., transmitters, receivers, and the like) allowing the locking device 300 to communicate wirelessly with external computing devices. For example, the wireless communications interface 302 may allow the locking device 300 to communicate via Bluetooth, Wi-Fi, near field communication protocols, or the like. For example, the locking device 300 may wirelessly receive the request to actuate the locking mechanism 104 via the wireless communications interface 302. The request may be initiated, for example, at an external computing device 320, such as a mobile phone or tablet. In other examples, the request may be initiated from the host computing device310. That is, rather than communicating the request via the receptacle interface 314, the host computing device310 may communicate the request via wireless communication protocols to the communications interface 302 of the locking device 300. In some examples, communications via the receptacle interface 314 between the receptacle 312 and the body 102 may be disabled.

In some examples, the processor 106 may further receive authentication data via the wireless communications interface 302 to perform an authentication on the request. The authentication data may be received concurrently with the request, as a part of the request, or the processor 106 may request the authentication data in response to receiving the request. In some examples, the authentication data may be received from external computing device 320 or from the host computing device310. The authentication data may be received from the same device from which the request was initiated, or from a different device. The authentication data may be received via wireless communication or via the receptacle interface 314.

For example, the host computing device 310 may initiate a request to actuate the locking mechanism 104 and communicate the request via the receptacle interface 314. In response to the request, the processor 106 may request authentication data from an authorized mobile device 320 via the wireless communications interface 302. The processor 106 may then receive the authentication data via the wireless communications interface 302. In other examples, the mobile device 320 may initiate the request to actuate the locking mechanism 104 and may communicate the request together with the authentication data to the wireless communications interface 302.

The locking device 300 further includes a power supply 304 to supply power to the locking device 304. The power supply 304 may be a battery, an energy harvester, or the like. The power supply 304 may be connected to the processor 106 and the wireless communications interface 302 to supply power thereto. More generally, the power supply 304 provides the locking device 300 with a self-contained power source, thereby enabling the processor 106 to perform authentication operations independently of the power state of the host computing device310. For example, the host computing device310 may be in an off state, a sleep state, a hibernation state, or other low-power state. The locking device 300 may therefore receive power to perform authentication operations from the power supply 304 rather than from the host computing device310 via the receptacle interface 314.

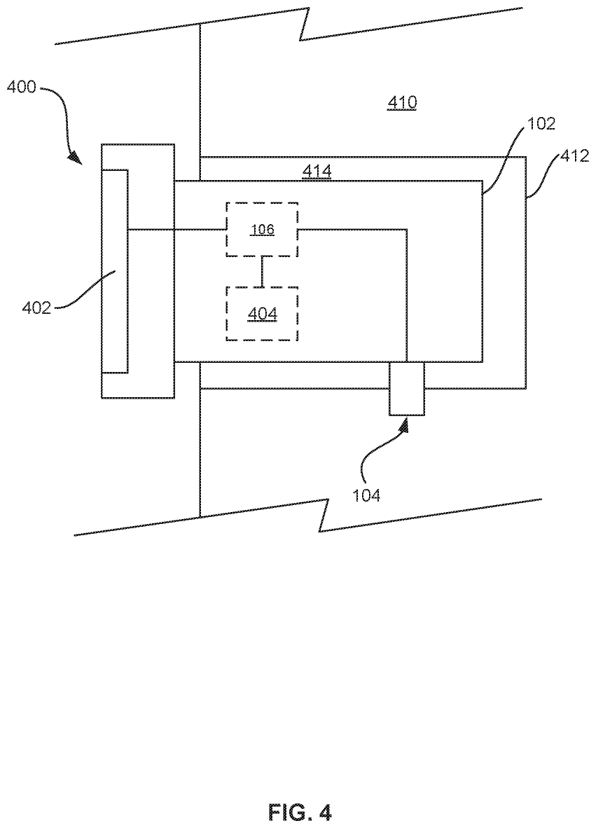

FIG. 4 depicts an example locking device 400 in a receptacle 412 of a host computing device 410. The locking device 400 includes a body 102 to interface with the receptacle 412 to form a receptacle interface 414. The locking device 400 further includes an electromechanical locking mechanism 104 disposed in the body 102 to engage the receptacle 412 to secure the body 102 in the receptacle 412. The locking device 400 further includes a processor 106 disposed in the body 102 and electrically connected to the locking mechanism 104 to actuate the locking mechanism 104. The locking device 400 further includes a power supply 404 connected to the processor 106 to provide power to the processor 106.

The locking device 400 further includes a security device 402 disposed in the body. The security device 402 receives input, for example, from a user, and generates authentication data for transmittal to the processor 106. For example, the security device 402 include a key pad, a fingerprint sensor, camera, another type of biometric sensor, or the like. The security device may generate authentication data such as the combination code entered in the key pad, biometric data representing the pattern of the biometric feature (e.g., iris, fingerprint, or the like) detected by the security device 402, or the like.

For example, the request to actuate the locking mechanism 104 may be initiated at the security device 402 and received directly at the processor 106. In some examples, the processor 106 may further receive authentication data generated at the security device 402 to perform an authentication on the request. The authentication data may be received concurrently with the request or as part of the request. In some examples, the authentication data and the request may be received from different devices or from the same device. In some examples, the authentication data and the request may also be received via wireless communication or via the receptacle interface 414.

For example, the host computing device 410 may initiate a request to actuate the locking mechanism 104 and communicate the request via the receptacle interface 414. In response to the request, the processor 106 may request authentication data from the security device 402. For example, the processor 106 may enable input to be received at the security device 402 (e.g., the processor 106 may turn on the fingerprint sensor to allow detection of fingerprint data by the fingerprint sensor). The processor 106 may then receive the authentication data via the direct connection to the security device 402. In other examples, a user may input data into the security device 402 (e.g., by scanning a fingerprint). Responsive to the input, the security device 402 may generate authentication data and may communicate a request to actuate the locking mechanism 104 together with the authentication data to the processor 106.

It should be apparent from the above that a locking device having a body to interface with a receptacle of a host computing device may include an electromechanical locking mechanism to engage the receptacle and a processor electrically connected to the electromechanical locking mechanism. The processor may receive a request to actuate the electromechanical locking mechanism and, in response to the request, perform an authentication on the request. The processor is to actuate the electromechanical locking mechanism in response to a successful authentication, In particular, the locking device may be a USB locking device, wherein the body is to interface with a USB receptacle of a host device, such as a computing device. The locking device may include a solenoid to allow the locking mechanism to be directly actuated by the processor. Further, the processor of the locking device performs authentication, thereby allowing receptacles to be locked independently of the power state or functionality of the host computing device. For example, the host computing device may be off, non-functional, inaccessible by the operator locking the port, or the like. For example, a computer technician may lock the ports of a computing device without requiring computer access for the technician. Further, the host computing device may be in an off state, a sleep state, a hibernation state, or another low power state. Further the performance of authentication by the processor allows the locking device to include a security device such as a fingerprint sensor to allow self-contained authentication functionality. The locking device therefore does not rely on communications to or from the host computing device, a server, or other computing device, and reduces the likelihood of receiving a falsely authenticated signal to actuate the locking mechanism from the host computing device or other computing device.

The scope of the claims should not be limited by the above examples, but should be given the broadest interpretation consistent with the description as a whole.

1. A locking device comprising:
a body to interface with a receptacle of a host computing device;
an electromechanical locking mechanism disposed in the body, the electromechanical locking mechanism to engage the receptacle to secure the body in the receptacle; and
a processor disposed in the body, the processor electrically connected to the electromechanical locking mechanism to actuate the electromechanical locking mechanism, the processor to receive a request to actuate the electromechanical locking mechanism and, in response to the request, perform an authentication on the request, wherein the processor is to actuate the electromechanical locking mechanism in response to a successful authentication.

2. The locking device of claim 1, wherein the electromechanical locking mechanism comprises a solenoid to interface with the processor to translate an actuation signal from the processor into mechanical actuation of the electromechanical locking mechanism.

3. The locking device of claim 1, wherein the electromechanical locking mechanism comprises a bolt to engage an aperture of the receptacle to secure the body in the receptacle.

4. The locking device of claim 1, further comprising a wireless communications interface to wirelessly receive the request, the request initiated at one of: an external device and the host computing device.

5. The locking device of claim 1, wherein the body is to interface with the receptacle to receive the request, the request initiated at the host computing device.

6. The locking device of claim 1, wherein the request is initiated at the locking device.

7. The locking device of claim 1, wherein the processor is further to receive authentication data, the processor to perform the authentication based on the authentication data.

8. The locking device of claim 7, wherein the authentication data comprises: a password, a pin, biometric data, or combinations of such.

9. The locking device of claim 7, wherein the authentication data is received from one of: an external device and the host computer.

10. The locking device of claim 7, further comprising a security device disposed in the body, the security device to receive input to generate the authentication data for transmittal to the processor.

11. The locking device of claim 10, wherein the security device comprises a fingerprint sensor.

12. The locking device of claim 1, wherein the body is to interface with the receptacle to draw power from the host computing device.

13. A non-transitory computer-readable medium storing a plurality of computer-readable instructions executable by a processor of a locking device, wherein execution of the instructions is to:
receive a request to actuate an electromechanical locking mechanism of the locking device, the electromechanical locking mechanism to engage a receptacle of a host computing device to secure the locking device in the receptacle;
in response to the request, perform an actuation on the request; and
in response to a successful authentication, actuate the electromechanical locking mechanism.

14. The non-transitory computer-readable medium of claim 13, wherein execution of the instructions to perform the actuation on the request comprises:
receiving authentication data; and
verifying the authentication data against authorized data.

15. A universal serial bus (USB) device comprising:
a body to interface with a USB receptacle of a host computing device;
an electromechanical locking mechanism disposed in the body, the electromechanical locking mechanism to engage the USB receptacle to secure the body in the USB receptacle; and
a processor disposed in the body, the processor electrically connected to the electromechanical locking mechanism to actuate the electromechanical locking mechanism, the processor to receive a request to actuate the electromechanical locking mechanism and, in response to the request, perform an authentication on the request, wherein the processor is to actuate the electromechanical locking mechanism in response to a successful authentication.
